(19) United States
(12) Patent Application Publication
(10) Pub. No.: US 2026/0008894 A1
(43) Pub. Date: Jan. 8, 2026

(54) WATERPROOF MEMBRANE BASED ON BIOMASS MODIFIED ASPHALT AND BIOMASS POLYESTER BASE

(71) Applicant: Yunnan Xincheng Waterproof SCI-TECH. Co., Ltd, Kunming City (CN)

(72) Inventors: Jiaxiang WANG, Kunming City (CN); Guanlin LIU, Kunming City (CN); Yunfei LI, Kunming City (CN)

(73) Assignee: Yunnan Xincheng Waterproof SCI-TECH. Co., Ltd, Kunming City (CN)

(21) Appl. No.: 19/244,843

(22) Filed: Jun. 20, 2025

(30) Foreign Application Priority Data
Jul. 4, 2024 (CN) 202410894507.X

(51) Int. Cl. C08J 5/12; C08L 95/00

(52) U.S. Cl. CPC C08J 5/12; C08L 95/00; C08J 2395/00; C08J 2423/06; C08J 2467/02; C08J 2483/04; C08L 2555/84

(57) ABSTRACT

A waterproof membrane based on biomass modified asphalt and a biomass polyester base is provided. A method for preparing the waterproof membrane using the prepared raw materials includes following steps: a, heating the modified biomass asphalt, adding the heavy calcium filler into the modified biomass asphalt, and stirring uniformly to obtain a composition, then pumping the composition into a modified biomass asphalt tank; b, immersing the bio-based polyethylene furanoate (PEF) base into the modified biomass asphalt tank for saturation; c, scraping off excess asphalt from the bio-based PEF base saturated with the modified biomass asphalt; d, after removing the excess modified biomass asphalt from the surface of the bio-based PEF base, cooling treatment is conducted; and e, after cooling, applying a silicon oil-coated polyethylene (PE) isolation layer on a surface to obtain a finished waterproof membrane.

### CROSS-REFERENCE TO RELATED APPLICATIONS

This application claims priority to Chinese Patent Application No. 202410894507.X, filed on Jul. 4, 2024 the contents of which are hereby incorporated by reference.

### TECHNICAL FIELD

The present disclosure relates to the field of waterproof membranes, and in particular to a waterproof membrane based on biomass modified asphalt and a biomass polyester base.

### BACKGROUND

With the continuous development of modern construction technology, waterproofing is a critical aspect of ensuring building quality and service life. Although traditional waterproof materials may meet waterproofing requirements to some extent, their durability, environmental friendliness, and aging resistance still need improvement. Especially under the current global advocacy for green, low-carbon, and sustainable development, developing a new type of waterproof material that is both efficient and environmentally friendly is particularly important.

Biomass modified asphalt, as a new environmentally friendly material, has attracted widespread attention in the field of building waterproofing in recent years. By introducing biomass materials into asphalt, the chemical structure and physical properties of asphalt are altered, improving its elasticity, aging resistance, and durability. Compared with traditional petroleum asphalt, biomass modified asphalt is not only abundant and renewable but also has a smaller environmental impact during production, aligning with the current trend of green building materials. Meanwhile, as an important component of waterproof membrane, the quality and performance of the polyester base directly affect the overall effectiveness of the membrane. Traditional polyester bases are mostly made from petroleum-based materials, which, although stable in performance, are costly and less environmentally friendly. Therefore, developing a polyester base based on biomass materials may not only reduce production costs but also improve the environmental performance of the product.

Although the combination of the above two materials has great potential in the field of waterproof membrane, no cases have been seen where the two are combined for waterproof membrane. The specific reason is that although current modified asphalt improves elasticity, aging resistance, and durability through the introduction of biomass materials, its performance still lags behind that of petroleum asphalt. Moreover, the strength of bio-based polyester bases still differs from that of petroleum-based bases. Therefore, the performance of waterproof membrane made by combining the two currently may not match that of traditional waterproof membrane. Additionally, for current biomass materials, the adhesive strength of biomass modified asphalt is often insufficient, making it difficult to bond well with biomass polyester bases. Forcibly combining the two for use would affect the final quality of the waterproof membrane. Based on these shortcomings, the disclosure proposes a waterproof membrane based on biomass modified asphalt and a biomass polyester base.

### SUMMARY

The purpose of the disclosure is to provide a waterproof membrane based on biomass modified asphalt and a biomass polyester base, solving the problem that the performance of existing waterproof materials made from the combination of biomass modified asphalt and biomass polyester bases may not match that of traditional waterproof materials.

To solve the above technical problems, the disclosure adopts the following technical scheme.

A waterproof membrane based on biomass modified asphalt and a biomass polyester base, where raw materials include modified biomass asphalt, a heavy calcium filler, and a bio-based polyethylene furanoate (PEF) base; and a method for preparing the waterproof membrane using the above raw materials includes following steps: a, heating the modified biomass asphalt, adding the prepared heavy calcium filler into the modified biomass asphalt after heating, stirring uniformly to obtain a composition, and then pumping the composition into a modified biomass asphalt tank; b, immersing the bio-based PEF base into the modified biomass asphalt tank for saturation; c, scraping off excess asphalt from the bio-based PEF base saturated with the modified biomass asphalt; d, after removing the excess modified biomass asphalt from the surface of the bio-based PEF base, conducting a cooling treatment; and e, after cooling, applying a silicon oil-coated polyethylene (PE) isolation layer on a surface to obtain a finished waterproof membrane.

Optionally, a method for preparing the modified biomass asphalt includes following steps: S1, preparing 95-105 parts by mass of base asphalt, 4.75-5.25 parts by mass of biomass oil, and 4.5-6.1 parts by mass of high-temperature tackifier as raw materials for the modified biomass asphalt; S2, heating the prepared base asphalt, adding the prepared biomass oil into the base asphalt, and stirring thoroughly to obtain biomass asphalt; and S3, further heating the obtained biomass asphalt, slowly and uniformly adding the prepared high-temperature tackifier, and stirring until the material is completely dissolved to obtain the modified biomass asphalt.

The addition of the high-temperature tackifier is to improve the performance of the asphalt, including:
1. enhancing the bonding strength between the modified asphalt and the bio-based PEF base to improve the overall strength of the membrane; and improving the bonding effect between the modified asphalt and the base interfaces, such as cement base interfaces, to prevent water leakage due to water infiltration;
2. improving the high-temperature performance of the asphalt (increasing the softening point) to prevent deformation of the waterproofing membrane caused by asphalt softening at high temperatures, thus avoiding compromised waterproofing effectiveness; and
3. increasing the elasticity of the asphalt, enabling the waterproof membrane to maintain certain deformation capacity under external forces and quickly recover its original shape after the external force disappears, thereby improving the fatigue resistance of the waterproof membrane.

The further heating in the S3 specifically refers to heating from 135-140 degrees Celsius (° C.) to 170-180° C. based on the S2.

Optionally, the mass fraction of the base asphalt is 100 parts, the mass fraction of the biomass oil is 5 parts, and the mass fraction of the high-temperature tackifier is 5 parts.

Optionally, a method for preparing the biomass oil is uniformly mixing 20-25 parts of straw dried to constant weight, 67.5-84.4 parts of liquefying agent, and 12.5-15.6 parts of catalyst, placing a mixture in a reaction kettle, sealing the reaction kettle, introducing nitrogen (N₂) for protection, adjusting an initial reaction pressure to 5 Megapascal (MPa), and reacting at 140° C.-150° C. for 120 minutes (min) to obtain the biomass oil after the above reaction.

Optionally, the mass fraction of the straw dried to constant weight is 20 parts, the mass fraction of the liquefying agent is 67.5 parts, and the mass fraction of the catalyst is 12.5 parts.

Optionally, the liquefying agent is prepared by mixing glycerol, Polyethylene Glycol (PEG)-400, and phenol in a mass ratio of 3:7:10, and the catalyst is 20 percent (%) sulfuric acid.

In the straw liquefying agent, glycerol acts as a stabilizer, which may prevent polycondensation reactions between small product molecules and improve product quality.

PEG-400 is used as a solvent and solubilizer in the straw liquefying agent. PEG-400 may effectively dissolve and disperse components such as cellulose, hemicellulose, and other organic substances in straw. As a solubilizer, PEG-400 may improve the fluidity of the liquefying agent, helping the liquid product penetrate and act on the straw more uniformly, thereby facilitating better straw liquefaction.

The role of phenol in the straw liquefying agent is mainly reflected in its degradation effect, solvent effect, and ability to provide active hydrogen.

As a nucleophilic reagent with lone electron pairs and x bonds, phenol readily undergoes electrophilic substitution with electrophilic reagents on the aromatic ring. This chemical property enables phenol to effectively break certain chemical bonds in straw, particularly the β-O-4 bonds in lignin and the glycosidic bonds between cellulose sugar rings. Such bond cleavage helps degrade macromolecules in straw into small molecular fragments, further promoting the liquefaction process of straw. Additionally, phenol has hydrogenated aromatic and phenolic hydroxyl structures, allowing it to act as both a solvent and a provider of large amounts of active hydrogen. Under high-temperature conditions, lignin macromolecules in straw may undergo free radical reactions under the action of phenol as a hydrogen-donating solvent, breaking into numerous low-molecular fragments. These fragments further form low-molecular-weight compounds through the breaking of side-chain C—C bonds, C—O bonds, and aromatic ring C—O bonds, thereby achieving efficient liquefaction of straw.

This ratio is derived from experiments, comprehensively considering the high yield and good stability of the biomass oil.

Optionally, the high-temperature tackifier is a prepared by compounding Styrene-Butadiene-Styrene block copolymer (SBS) and Styrene-Butadiene Rubber (SBR) in a mass ratio of 1:0.2-0.5.

Optionally, the reaction conditions for each step in the preparation of the modified biomass asphalt are as follows: in the S2, the prepared base asphalt is heated, and specifically, the prepared base asphalt is heated to 135-140° C., and thorough stirring is performed at 900-950 revolutions per minute (r/min) for 40-50 min; further heating the obtained biomass asphalt in the S3 means heating the biomass asphalt obtained in the S2 to 170-180° C., and the prepared high-temperature tackifier is added slowly and uniformly while stirring at 400-600 r/min.

Optionally, in the S2, the prepared base asphalt is heated, and specifically, the prepared base asphalt is heated to 135° C., and thorough stirring is performed at 950 r/min for 45 min.

Optionally, a method for preparing the bio-based PEF base includes following steps: K1, conducting an esterification reaction between a bio-based aromatic monomer 2,5-furandicarboxylic acid (FDCA) and ethylene glycol (EG) to synthesize PEF; and K2, melting the obtained PEF synthesized in the K1, adding glass fibers, and then performing extrusion molding or calendering to obtain the bio-based PEF base.

Optionally, in the K1, a mass ratio of the bio-based aromatic monomer FDCA to EG is 1:0.59-1:0.73; and the conditions for the esterification reaction are as follows:
first, oligomers are prepared through esterification. FDCA and EG are added to a vacuum reaction kettle according to the mass ratio, along with the catalyst butyl titanate (the mass ratio of the catalyst to FDCA is 1:200) and the antioxidant triphenyl phosphite (the mass ratio of the additive to FDCA is between 1:142.9 and 1:121.5). Under N₂ protection, the temperature is slowly raised from 60° C. to 180° C. for direct esterification. After the reaction system reaches the clarity point, the reaction continues until no more liquid precipitates in the condenser, then terminate the esterification to form oligomers.

Then, the vacuum is slowly reduced to below 600 Pascal (Pa), the temperature is raised to 210-250° C., and stirring is performed at 200 r/min for pre-polycondensation. After 120 min of reaction, the pre-polycondensation is completed. Subsequently, the reaction system is evacuated to high vacuum. As the reaction proceeds, the viscosity of the reactants increases, and the stirrer speed is increased to 400 r/min. After 45-60 min, the polycondensation is completed.

Finally, a mixed solution of phenol/tetrachloroethylene in a mass ratio of 1:1 is used as the solvent to completely dissolve the Poly(2,5-furandimethylene) (PHF) product obtained from polycondensation, and insoluble impurities are filtered out. Then methanol is added to the solution to precipitate the product. The precipitation is filtered out when no more precipitate forms. The dissolution and precipitation steps are repeated three times, collect the precipitate and dry it to obtain the purified PEF product.

Optionally, a mass ratio of an added amount of the glass fibers to the PEF is 1:200.

The addition of glass fibers affects the waterproof membrane mainly in the following aspects:

1. enhanced mechanical properties: as an inorganic non-metallic material, glass fibers, exhibits high strength and high modulus characteristics. When added to the base material, they may significantly improve the tensile strength and tear resistance of the membrane, thereby enhancing its overall mechanical performance.

2. Improved durability: glass fibers demonstrate excellent chemical stability and corrosion resistance, enabling the waterproof membrane with glass fiber-reinforced base material to better resist chemical corrosive media such as acids and alkalis, thereby extending the service life of the membrane.

3. Enhanced thermal stability: glass fibers have good thermal stability, maintaining the stable shape of the base material during high-temperature processing and tensile environments in the production of waterproof membrane, and preventing deformation or damage.

Optionally, the reaction conditions for each step in preparation of the waterproof membrane are as follows: in the step a, heating the modified biomass asphalt specifically refers to heating the modified biomass asphalt to 160-165° C.; adding the prepared heavy calcium filler into the modified biomass asphalt specifically refers to adding the heavy calcium filler with a particle size of 120-150 meshes into the modified biomass asphalt, an addition of the heavy calcium filler accounts for 27%-33% of a mass of the modified biomass asphalt, and the composition is obtained by stirring at 400-500 r/min for 30-45 min; in the step c, after the excess asphalt scraping operation, a standardized-thickness biomass-modified asphalt waterproof layer is formed, with a biomass modified asphalt film thickness of 1.2 millimeters (mm) after scraping.

Compared with the prior art, the disclosure achieves at least one of the following beneficial effects.

Environmental sustainability: biomass asphalt is derived from animal and plant resources such as waste wood, crop straw, and waste animal and vegetable oils. These resources are renewable, and compared with petroleum asphalt, the wastewater and exhaust gas generated during their extraction and processing are less, resulting in relatively lower environmental pollution. Therefore, the use of biomass asphalt helps reduce dependence on fossil fuels, lower greenhouse gas and pollutant emissions, and protect the ecological environment. Since bio-based raw materials are used, the PEF base asphalt waterproof membrane may be more easily decomposed by the natural environment after reaching the end of its service life, thereby reducing pollution to soil and water bodies, aligning with the development trend of green building.

Excellent waterproofing performance: biomass asphalt has good weather resistance, appropriate softening point, and viscosity, enabling it to maintain good performance stability under harsh conditions such as high temperature, low temperature, and humidity. It improves the fatigue resistance of the mixture, making it less prone to cracking and deterioration. This characteristic gives biomass asphalt unique advantages in the field of building waterproofing. The PEF base has good tensile strength and elongation, and the addition of glass fibers during production further improves material strength, effectively resisting deformation under external forces and maintaining the integrity of the waterproof layer.

The specifications and dimensions of this waterproof membrane are usually standardized, making it easy to transport and store. During construction, it may be laid using hot-melt or cold-adhesive methods, with simple operation and high efficiency, helping to shorten the construction period.

Good aging resistance: the presence of carbon particles and low-polarity molecules in biomass asphalt gives it excellent anti-aging and anti-ultraviolet properties. The PEF base material has good weather resistance and chemical corrosion resistance, enabling it to resist erosion by natural factors such as ultraviolet rays and thermal oxidation, thereby extending the service life of the waterproof layer.

Economic efficiency: biomass asphalt is derived from animal and plant resources such as waste wood, crop straw, and waste animal and vegetable oils. These resources are widely available, renewable, easy to obtain, and the production cost of biomass asphalt is relatively low. This gives it stronger competitiveness in areas with scarce resources or projects with high environmental requirements. Additionally, PEF is synthesized from bio-based monomers 2,5-furandicarboxylic acid (FDCA) and ethylene glycol (EG), where FDCA may be obtained from starch, cellulose, and other biomass resources through a series of reactions, and EG may also be produced from biomass raw materials. This characteristic of being derived from renewable biomass resources reduces the purchase of petroleum raw materials during production. Moreover, as a recyclable and degradable polymer, PEF may be effectively recycled and processed after use, further reducing material costs.

The waterproof membrane combines the biomass polyester base with modified asphalt to form a strong and durable waterproof layer. This waterproof membrane not only inherits the excellent performance of biomass modified asphalt but also further improves the durability and environmental friendliness of the membrane by optimizing the base material. In specific implementations, the disclosure carefully selects biomass materials and modification processes to effectively improve the performance of asphalt. At the same time, by optimizing the production process and structural design of the base material, the stability and reliability of the waterproof membrane are ensured. Additionally, the disclosure emphasizes the environmental performance of the product, further reducing the environmental burden during production by selecting low-pollution, easily recyclable materials and production processes. In summary, the waterproof membrane based on biomass modified asphalt and biomass polyester base not only aligns with the current development trend in the field of building waterproofing but also has broad market prospects and application value. With the further promotion and application of this technology, it is believed to bring revolutionary changes to the field of building waterproofing and make positive contributions to the sustainable development of society.

### BRIEF DESCRIPTION OF THE DRAWINGS

In order to explain the technical scheme of the present disclosure more clearly, the drawings needed in the embodiments are briefly introduced below. Obviously, the drawings in the following description are only some embodiments of the present disclosure. For ordinary people in the field, other drawings may be obtained according to these drawings without paying creative labor.

FIG. 1 is the flow chat for preparing the waterproof membrane according to an embodiment of the present closure.

FIG. 2 is the flow chat for preparing the modified biomass asphalt according to an embodiment of the present closure.

FIG. 3 is the flow chat for preparing the bio-based polyethylene furanoate (PEF) base according to an embodiment of the present closure.

### DETAILED DESCRIPTION OF THE EMBODIMENTS

To make the objectives, technical schemes, and advantages of the embodiments of the disclosure clearer, the technical schemes in the embodiments of the disclosure will be described clearly and completely in conjunction with the embodiments of the disclosure. Obviously, the described embodiments are only a part of the embodiments of the disclosure, not all of them. Generally, the components of the embodiments of the disclosure described and illustrated herein may be arranged and designed in various configurations.

Therefore, the following detailed description of the embodiments of the disclosure is not intended to limit the scope of the claimed disclosure but merely represents selected embodiments of the disclosure. Based on the embodiments of the disclosure, all other embodiments obtained by those of ordinary skill in the art without creative efforts shall fall within the protection scope of the disclosure.

It should be noted that, in the absence of conflict, the embodiments and features in the embodiments of the disclosure may be combined with each other.

### Embodiment 1

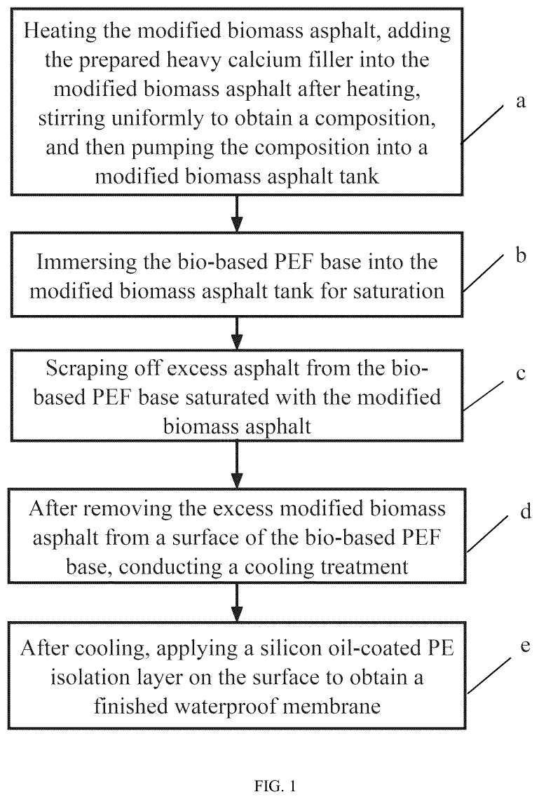

A waterproof membrane based on biomass modified asphalt and a biomass polyester base, including the following steps: a, heating the modified biomass asphalt to 160 degrees Celsius (° C.), adding the prepared 120-mesh heavy calcium filler into the modified biomass asphalt while stirring at 450 revolutions per minute (r/min) for 35 minutes (min) until uniform mixing is achieved to obtain a composition, where the amount of heavy calcium filler added is 30% of the mass of the modified biomass asphalt, and then pumping the composition into a modified biomass asphalt tank; b, immersing the bio-based polyethylene furanoate (PEF) base into the modified biomass asphalt tank for saturation; c, scraping off excess asphalt from the bio-based PEF base saturated with the modified biomass asphalt, and forming a biomass modified asphalt waterproof layer with a film thickness of 1.2 millimeters (mm) after scraping; d, after removing the excess modified biomass asphalt from the surface of the bio-based PEF base, conducting a cooling treatment; and e, after cooling, applying a silicon oil-coated polyethylene (PE) isolation layer on a surface to obtain a finished waterproof membrane (as shown in FIG. 1); where

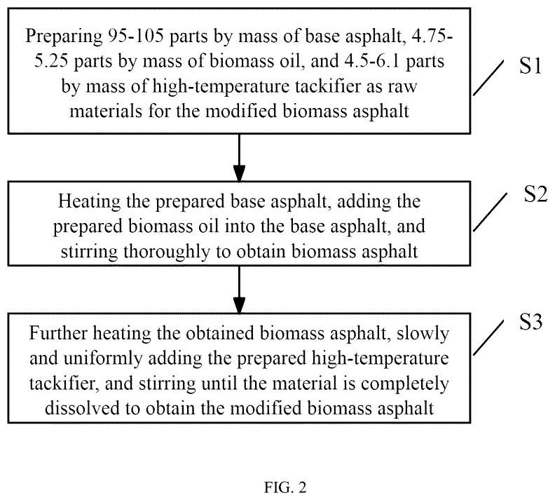

a method for preparing the modified biomass asphalt includes following steps: S1, preparing 100 parts by mass of base asphalt, 5 parts by mass of biomass oil, and 5 parts by mass of high-temperature tackifier as raw materials for the modified biomass asphalt; S2, heating the prepared base asphalt, adding the prepared biomass oil into the base asphalt, and stirring thoroughly to obtain biomass asphalt; and S3, further heating the obtained biomass asphalt, slowly and uniformly adding the prepared high-temperature tackifier, and stirring until the material is completely dissolved to obtain the modified biomass asphalt (as shown in FIG. 2);

a method for preparing the biomass oil is uniformly mixing 20 parts of straw dried to constant weight, 67.5 parts of liquefying agent, and 12.5 parts of catalyst, placing in a reaction kettle, sealing the reaction kettle, introducing N₂ for protection, adjusting an initial reaction pressure to 5 MPa, and reacting at 140° C. for 120 min to obtain the biomass oil after the above reaction;

the liquefying agent is prepared by mixing glycerol, Polyethylene Glycol (PEG) 400, and phenol in a mass ratio of 3:7:10, and the catalyst is 20% sulfuric acid;

the high-temperature tackifier is a prepared by compounding Styrene-Butadiene-Styrene block copolymer (SBS) and Styrene-Butadiene Rubber (SBR) in a mass ratio of 1:0.2;

the reaction conditions for each step in the preparation of the modified biomass asphalt are as follows: in the S2, the prepared base asphalt is heated, and specifically, the prepared base asphalt is heated to 135° C., and thorough stirring is performed at 950 r/min for 45 min; further heating the obtained biomass asphalt in the S3 means heating the biomass asphalt obtained in the S2 to 180° C., and the prepared high-temperature tackifier is added slowly and uniformly while stirring at 500 r/min;

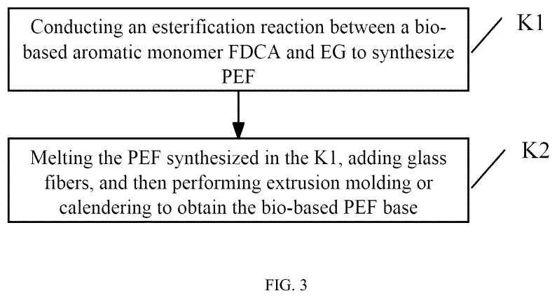

a method for preparing the bio-based PEF base includes following steps: K1, conducting an esterification reaction between a bio-based aromatic monomer 2,5-furandicarboxylic acid (FDCA) and ethylene glycol (EG) to synthesize PEF; K2, melting the PEF synthesized in the K1, adding glass fibers, and then performing extrusion molding or calendering to obtain the bio-based PEF base (as shown in FIG. 3);
in the K1, a mass ratio of the bio-based aromatic monomer FDCA and EG is 1:0.59, and the conditions for the esterification reaction are as follows:
first, oligomers are prepared through esterification. FDCA and EG are added to a vacuum reaction kettle according to the mass ratio, along with the catalyst butyl titanate (the mass ratio of the catalyst to FDCA is 1:200) and the antioxidant triphenyl phosphite (the mass ratio of the additive to FDCA is 1:130). Under N₂ protection, the temperature is slowly raised from 60° C. to 180° C. for direct esterification. After the reaction system reaches the clarity point, the reaction continues until no more liquid precipitates in the condenser, then terminate the esterification to form oligomers;
then, the vacuum is slowly reduced to below 600 Pascal (Pa), the temperature is raised to 210° C., and stirring is performed at 200 r/min for pre-polycondensation. After 120 min of reaction, the pre-polycondensation is completed. Subsequently, the reaction system is evacuated to high vacuum. As the reaction proceeds, the viscosity of the reactants increases, and the stirrer speed is increased to 400 r/min. After 60 min, the polycondensation is completed;
finally, a mixed solution of phenol/tetrachloroethylene in a mass ratio of 1:1 is used as the solvent to completely dissolve the Poly(2,5-furandimethylene) (PHF) product obtained from polycondensation, and insoluble impurities are filtered out. Then methanol is added to the solution to precipitate the product. The precipitation is filtered out when no more precipitate forms. The dissolution and precipitation steps are repeated three times, collect the precipitate and dry it to obtain the purified PEF product; and
a mass ratio of the added amount of the glass fibers to PEF is 1:200.

### Embodiment 2

A waterproof membrane based on biomass modified asphalt and a biomass polyester base, including the following steps: a, heating the modified biomass asphalt to 165° C., adding the prepared 130-mesh heavy calcium filler into the modified biomass asphalt while stirring at 500 r/min for 45 min until uniform mixing is achieved to obtain a composition, where the amount of heavy calcium filler added is 27% of the mass of the modified biomass asphalt, and then pumping the composition into a modified biomass asphalt tank; b, immersing the bio-based PEF base into the modified biomass asphalt tank for saturation; c, scraping off excess asphalt from the bio-based PEF base saturated with the modified biomass asphalt, and forming a biomass modified asphalt waterproof layer with a film thickness of 1.2 mm after scraping; d, after removing the excess modified biomass asphalt from the surface of the bio-based PEF base, conducting a cooling treatment; and e, after cooling, applying a silicon oil-coated PE isolation layer on a surface to obtain a finished waterproof membrane (as shown in FIG. 1); where

a method for preparing the modified biomass asphalt includes following steps: S1, preparing 105 parts by mass of base asphalt, 4.75 parts by mass of biomass oil, and 6.1 parts by mass of high-temperature tackifier as raw materials for the modified biomass asphalt; S2, heating the prepared base asphalt, adding the prepared biomass oil into the base asphalt, and stirring thoroughly to obtain biomass asphalt; S3, further heating the obtained biomass asphalt, slowly and uniformly adding the prepared high-temperature tackifier, and stirring until the material is completely dissolved to obtain the modified biomass asphalt (as shown in FIG. 2);

a method for preparing the biomass oil is uniformly mixing 22 parts by mass of straw dried to constant weight, 80 parts of liquefying agent, and 15 parts of catalyst uniformly in a reaction kettle, sealing the reaction kettle, introducing N₂ for protection, adjusting an initial reaction pressure to 5 MPa, and reacting at 150° C. for 120 min to obtain the biomass oil after the above reaction;
the liquefying agent is prepared by mixing glycerol, PEG-400, and phenol in a mass ratio of 3:7:10, and the catalyst is 20% sulfuric acid;
the high-temperature tackifier is a prepared by compounding SBS and SBR in a mass ratio of 1:0.5;
the reaction conditions for each step in the preparation of the modified biomass asphalt are as follows: in the S2, the prepared base asphalt is heated, and specifically, the prepared base asphalt is heated to 140° C., and thorough stirring is performed at 900 r/min for 40 min; further heating the obtained biomass asphalt in the S3 means heating the biomass asphalt obtained in the S2 to 170° C., and the prepared high-temperature tackifier is added slowly and uniformly while stirring at 400 r/min;
a method for preparing the bio-based PEF base includes following steps: K1, conducting an esterification reaction between a bio-based aromatic monomer FDCA and EG to synthesize PEF; K2, melting the PEF synthesized in the K1, adding glass fibers, and then performing extrusion molding or calendering to obtain the bio-based PEF base (as shown in FIG. 3);
in the K1, a mass ratio of the bio-based aromatic monomer FDCA and EG is 1:0.65, and the conditions for the esterification reaction are as follows:
first, oligomers are prepared through esterification. FDCA and EG are added to a vacuum reaction kettle according to the mass ratio, along with the catalyst butyl titanate (the mass ratio of the catalyst to FDCA is 1:200) and the antioxidant triphenyl phosphite (the mass ratio of the additive to FDCA is 1:142.9). Under N₂ protection, the temperature is slowly raised from 60° C. to 180° C. for direct esterification. After the reaction system reaches the clarity point, the reaction continues until no more liquid precipitates in the condenser, then terminate the esterification to form oligomers;
then, the vacuum is slowly reduced to below 600 Pa, the temperature is raised to 230° C., and stirring is performed at 200 r/min for pre-polycondensation. After 120 min of reaction, the pre-polycondensation is completed. Subsequently, the reaction system is evacuated to high vacuum. As the reaction proceeds, the viscosity of the reactants increases, and the stirrer speed is increased to 400 r/min. After 45 min, the polycondensation is completed;
finally, a mixed solution of phenol/tetrachloroethylene in a mass ratio of 1:1 is used as the solvent to completely dissolve the PHF product obtained from polycondensation, and insoluble impurities are filtered out. Then methanol is added to the solution to precipitate the product. The precipitation is filtered out when no more precipitate forms. The dissolution and precipitation steps are repeated three times, collect the precipitate and dry it to obtain the purified PEF product; and
a mass ratio of an added amount of the glass fibers to the PEF is 1:200.

### Embodiment 3

A waterproof membrane based on biomass modified asphalt and a biomass polyester base, including the following steps: a, heating the modified biomass asphalt to 162° C., adding the prepared 150-mesh heavy calcium filler into the modified biomass asphalt while stirring at 400 r/min for 30 min until uniform mixing is achieved to obtain a composition, where the amount of heavy calcium filler added is 33% of the mass of the modified biomass asphalt, and then pumping the composition into a modified biomass asphalt tank; b, immersing the bio-based PEF base into the modified biomass asphalt tank for saturation; c, scraping off excess asphalt from the bio-based PEF base saturated with the modified biomass asphalt, and forming a biomass modified asphalt waterproof layer with a film thickness of 1.2 mm after scraping; d, after removing the excess modified biomass asphalt from the surface of the bio-based PEF base, conducting a cooling treatment; and e, after cooling, applying a silicon oil-coated PE isolation layer on a surface to obtain a finished waterproof membrane (as shown in FIG. 1); where
a method for preparing the modified biomass asphalt includes following steps: S1, preparing 95 parts by mass of base asphalt, 5.25 parts by mass of biomass oil, and 4.5 parts by mass of high-temperature tackifier as raw materials for the modified biomass asphalt; S2, heating the prepared base asphalt, adding the prepared biomass oil into the base asphalt, and stirring thoroughly to obtain biomass asphalt; S3, further heating the obtained biomass asphalt, slowly and uniformly adding the prepared high-temperature tackifier, and stirring until the material is completely dissolved to obtain the modified biomass asphalt (as shown in FIG. 2);
a method for preparing the biomass oil includes: mixing 25 parts of straw dried to constant weight, 84.4 parts of liquefying agent, and 15.6 parts of catalyst uniformly in a reaction kettle, sealing the reaction kettle, introducing N₂ for protection, adjusting an initial reaction pressure to 5 MPa, and reacting at 145° C. for 120 min to obtain the biomass oil after the above reaction;
the liquefying agent is prepared by mixing glycerol, PEG-400, and phenol in a mass ratio of 3:7:10, and the catalyst is 20% sulfuric acid;
the high-temperature tackifier is a prepared by compounding SBS and SBR in a mass ratio of 1:0.3;
the reaction conditions for each step in the preparation of the modified biomass asphalt are as follows: in the S2, the prepared base asphalt is heated, and specifically, the prepared base asphalt is heated to 138° C., and thorough stirring is performed at 920 r/min for 50 min; further heating the obtained biomass asphalt in the S3 means heating the biomass asphalt obtained in the S2 to 178° C., and the prepared high-temperature tackifier is added slowly and uniformly while stirring at 600 r/min;
a method for preparing the bio-based PEF base includes following steps: K1, conducting an esterification reaction between a bio-based aromatic monomer FDCA and EG to synthesize PEF; K2, melting the PEF synthesized in the K1, adding glass fibers, and then performing extrusion molding or calendering to obtain the bio-based PEF base (as shown in FIG. 3);
in the K1, a mass ratio of the bio-based aromatic monomer FDCA and EG is 1:0.73, and the conditions for the esterification reaction are as follows:
first, oligomers are prepared through esterification. FDCA and EG are added to a vacuum reaction kettle according to the mass ratio, along with the catalyst butyl titanate (the mass ratio of the catalyst to FDCA is 1:200) and the antioxidant triphenyl phosphite (the mass ratio of the additive to FDCA is 1:121.5). Under N₂ protection, the temperature is slowly raised from 60° C. to 180° C. for direct esterification. After the reaction system reaches the clarity point, the reaction continues until no more liquid precipitates in the condenser, then terminate the esterification to form oligomers;
then, the vacuum is slowly reduced to below 600 Pa, the temperature is raised to 250° C., and stirring is performed at 200 r/min for pre-polycondensation. After 120 min of reaction, the pre-polycondensation is completed. Subsequently, the reaction system is evacuated to high vacuum. As the reaction proceeds, the viscosity of the reactants increases, and the stirrer speed is increased to 400 r/min. After 50 min, the polycondensation is completed;
finally, a mixed solution of phenol/tetrachloroethylene in a mass ratio of 1:1 is used as the solvent to completely dissolve the PHF product obtained from polycondensation, and insoluble impurities are filtered out. Then methanol is added to the solution to precipitate the product. The precipitation is filtered out when no more precipitate forms. The dissolution and precipitation steps are repeated three times, collect the precipitate and dry it to obtain the purified PEF product; and
a mass ratio of an added amount of the glass fibers to the PEF is 1:200.

The products in the embodiments are tested, and the test results are as follows:

The testing methods are conducted according to the methods disclosed in GB 23441-2009 “Self-adhesive Polymer Modified Asphalt Waterproofing Membrane,” PY Class I.

TABLE 1

| | | | | | Glass Fiber- |
|---|---|---|---|---|---|
| | | | National | Bio-Based | Reinforced Bio- |
| | | | Standard | PEF Base | Based PEF Base |
| Test | | | Technical | Waterproof | Waterproof |
| Item | Test Parameter | | Indicator | Membrane | Membrane |
| 1 | Tensile strength/ | | ≥450 | 510 | 582 |
| | (N/50 mm) | | | | |
| 2 | Elongation at maximum | | ≥30 | 55 | 45 |
| | tensile strength/% | | | | |
| 3 | Impermeability | | 0.3 MPa, | 0.5 MPa, | 0.5 MPa, |
| | | | 120 min, | 120 min, | 120 min, |
| | | | impermeable | impermeable | impermeable |
| 4 | Heat resistance, 70° C., | | 70° C., | 85° C., | 85° C., |
| | sliding ≤2 mm | | sliding ≤2 mm | no sliding | no sliding |
| 5 | Low-temperature | | −20° C., | −20° C., | −20° C., |
| | flexibility | | no cracks | no cracks | no cracks |
| 6 | Peel | Membrane to | ≥1.0 | 3.5 | 3.7 |
| | Strength | membrane | | | |
| 7 | (N/mm) | Membrane to | ≥1.5 | 5.1 | 5.2 |
| | | aluminum | | | |
| | | plate | | | |
| 8 | Oil Seepage/Number of | | ≤2 sheets | 1 | 1 |
| | Sheets | | | | |
| 9 | Holding Time/min | | ≥15 | >60 min | >60 min |
| 11 | Thermal | Appearance | No blistering, | No blistering, | No blistering, |
| | Stability | | dripping, | dripping, | dripping, |
| | | | sliding, or | sliding, or | sliding, or |
| | | | flowing | flowing | flowing |
| | | Dimensional | 1.5 | 0.8 | 0.4 |
| | | Stability/%≤ | | | |
| | | Elongation at | 30 | 67 | 51 |
| | | Maximum | | | |
| | | Tensile | | | |
| | | Strength/%≤ | | | |

Although the disclosure has been described in detail with reference to the foregoing embodiments, for those skilled in the art, modifications to the technical schemes described in the embodiments or equivalent replacements of some technical features may still be made. Any modifications, equivalent replacements, or improvements made within the spirit and principles of the disclosure shall be included in the protection scope of the disclosure.

What is claimed is:

1. A waterproof membrane based on biomass modified asphalt and a biomass polyester base, wherein raw materials comprise modified biomass asphalt, a heavy calcium filler, and a bio-based polyethylene furanoate (PEF) base, wherein a method for preparing the waterproof membrane using the raw materials comprises following steps:
a: heating the modified biomass asphalt, adding the prepared heavy calcium filler into the modified biomass asphalt after heating, stirring uniformly to obtain a composition, and then pumping the composition into a modified biomass asphalt tank;
b: immersing the bio-based PEF base into the modified biomass asphalt tank for saturation;
c: scraping off excess asphalt from the bio-based PEF base saturated with the modified biomass asphalt;
d: after removing the excess modified biomass asphalt from a surface of the bio-based PEF base, conducting a cooling treatment; and
e: after cooling, applying a silicon oil-coated PE isolation layer on the surface to obtain a finished waterproof membrane;
wherein a method for preparing the bio-based PEF base comprises following steps:
K1: conducting an esterification reaction between a bio-based aromatic monomer FDCA and EG to synthesize PEF; and
K2: melting the PEF synthesized in the K1, adding glass fibers for blending, and then performing extrusion molding or calendering to obtain the bio-based PEF base;
wherein in the K1, a mass ratio of the bio-based aromatic monomer FDCA to the EG is 1:0.59-1:0.73;
a mass ratio of an added amount of the glass fibers to the PEF is 1:200;
wherein a method for preparing the modified biomass asphalt comprises following steps:
S1: preparing 95-105 parts by mass of base asphalt, 4.75-5.25 parts by mass of biomass oil, and 4.5-6.1 parts by mass of high-temperature tackifier as raw materials for the modified biomass asphalt;
S2: heating the prepared base asphalt, adding the prepared biomass oil into the base asphalt, and stirring thoroughly to obtain biomass asphalt; and
S3: further heating the obtained biomass asphalt, slowly and uniformly adding the prepared high-temperature tackifier, and stirring until the material is completely dissolved to obtain the modified biomass asphalt.

2. The waterproof membrane based on the biomass modified asphalt and the biomass polyester base according to claim 1, wherein a preparation method for the biomass oil comprises:
uniformly mixing 20-25 parts of straw dried to constant weight, 67.5-84.4 parts of liquefying agent, and 12.5-15.6 parts of catalyst,
placing a mixture in a reaction kettle,
sealing the reaction kettle,
introducing N₂ for protection, and
adjusting an initial reaction pressure to 5 MPa, and reacting at 140° C.-150° C. for 120 min to obtain the biomass oil after the above reaction.

3. The waterproof membrane based on the biomass modified asphalt and the biomass polyester base according to claim 2, wherein the liquefying agent is prepared by mixing glycerol, PEG-400, and phenol in a mass ratio of 3:7:10, and the catalyst is 20% sulfuric acid.

4. The waterproof membrane based on the biomass modified asphalt and the biomass polyester base according to claim 1, wherein the high-temperature tackifier is prepared by compounding SBS and SBR in a mass ratio of 1:0.2-0.5.

5. The waterproof membrane based on the biomass modified asphalt and the biomass polyester base according to claim 1, wherein reaction conditions for each step in the preparation of the modified biomass asphalt are as follows:
in the S2, the prepared base asphalt is heated, and specifically, the prepared base asphalt is heated to 135-140° C., and thorough stirring is performed at 900-950 r/min for 40-50 min; and
further heating the obtained biomass asphalt in the S3 means heating the biomass asphalt obtained in the S2 to 170-180° C., and the prepared high-temperature tackifier is added slowly and uniformly while stirring at 400-600 r/min.

6. The waterproof membrane based on the biomass modified asphalt and the biomass polyester base according to claim 1, wherein reaction conditions for each step in the preparation of the waterproof membrane are as follows:
in the step a, heating the modified biomass asphalt specifically refers to heating the modified biomass asphalt to 160-165° C.; adding the prepared heavy calcium filler into the modified biomass asphalt specifically refers to adding the heavy calcium filler with a particle size of 120-150 meshes into the modified biomass asphalt, an addition of the heavy calcium filler accounts for 27%-33% of a mass of the modified biomass asphalt, and the composition is obtained by stirring at 400-500 r/min for 30-45 min; and
in the step c, the excess asphalt scraping operation specifically refers to forming a biomass modified asphalt waterproof layer with a biomass modified asphalt film thickness of 1.2-2.0 mm after scraping.
